(19) United States
(12) Patent Application Publication
(10) Pub. No.: US 2023/0227632 A1
(43) Pub. Date: Jul. 20, 2023

(54) MUD MATERIAL

(71) Applicant: SHINAGAWA REFRACTORIES CO., LTD., Tokyo (JP)

(72) Inventor: Yuga YAMAMOTO, Tokyo (JP)

(73) Assignee: SHINAGAWA REFRACTORIES CO., LTD., Tokyo (JP)

(21) Appl. No.: 18/127,867

(22) Filed: Mar. 29, 2023

Related U.S. Application Data
(63) Continuation of application No. PCT/JP2021/044742, filed on Dec. 6, 2021.

(30) Foreign Application Priority Data
Dec. 11, 2020 (JP) 2020-205976

(51) Int. Cl. C08K 13/02; C21B 7/12

(52) U.S. Cl. CPC C08K 13/02; C21B 7/125; C08K 5/34922

(57) ABSTRACT

Disclosed herein is a mud material comprising a refractory raw material, an organic binder, and a curing agent, wherein part or all of the organic binder is a novolac-type phenol resin, part or all of the curing agent is a methylene donor, and wherein the methylene donor is at least one selected from the group consisting of hexa(methoxymethyl)melamine and hexamethoxymethylolmelamine.

### CROSS-REFERENCE TO RELATED APPLICATIONS

This application is a continuation of International Patent Application No. PCT/JP2021/044742, having an international filing date of Dec. 6, 2021, which designated the United States, the entirety of which is incorporated herein by reference. Japanese Patent Application No.2020-205976 filed on Dec. 11, 2020 is also incorporated herein by reference in its entirety.

### BACKGROUND OF THE INVENTION

The present disclosure relates to a mud material used to plug a blast furnace taphole.

### DESCRIPTION OF THE RELATED ART

The taphole of a blast furnace is plugged with a mud material injected thereinto. The adhesive strength between the taphole and the mud material needs to immediately be developed after plugging. The mud material is a refractory material like a clay paste and is produced by mixing a refractory raw material and an organic binder. The adhesive strength is developed mainly by the organic binder. As the organic binder, coal tar is often used. However, coal tar has a strong odor. Therefore, a phenol resin may be used as the organic binder to reduce odor.

Here, tapping refers to discharging hot metal from a blast furnace by opening a hole in a sintered and cured mud material. During tapping, the mud material comes into contact with the discharged hot metal and slag. Therefore, the mud material needs to withstand erosion by the slag and prevent an increase (enlargement) in the diameter of the taphole. That is, the mud material is required to have excellent erosion resistance. However, a mud material containing a phenol resin may be inferior in erosion resistance to a mud material containing coal tar. Therefore, a curing agent may be added to a mud material containing a phenol resin. The phenol resin is polymerized and cured by the curing agent and the heat of a blast furnace to develop adhesive strength.

Meanwhile, when exported from Japan, a mud material may pass the equator and therefore be exposed to high temperature for a long time. Even after such transport and storage, the mud material needs to maintain fluidity suitable for injection without a temporal change. However, there is a case where a mud material containing a phenol resin and a curing agent cannot maintain fluidity suitable for injection due to a temporal change caused by a change in environment during transport and storage so that development of adhesive strength is poor. In order to solve such problems, JP-A-2018-158870 discloses a mud material characterized in that (1) a novolac-type phenol resin having a weight-average molecular weight of 3000 to 10000 is used as an organic binder, (2) hexamethylenetetramine (hexamine) is used as a curing agent, and (3) a content of the hexamethylenetetramine is 0.5 to 3.0 mass % in outer percentage with respect to 100 mass % of the novolac-type phenol resin.

Further, the front of a blast furnace is at a high temperature, and therefore the temperature of a mud gun increases so that a phenomenon may occur in which a mud material charged in the mud gun is cured and sticks to the inside of the mud gun. In order to prevent clogging of a mud gun due to such a phenomenon, JP-A-11-158517 discloses a device and a method for cooling the outer surface of a mud gun by spraying mist.

The mud material disclosed in JP-A-2018-158870 exhibits the effect of reducing a temporal change in fluidity and resistance to erosion by slag to some extent, but it cannot be said that the effect and the erosion resistance are sufficient. Further, the device for preventing clogging of a mud gun disclosed in JP-A-11-158517 requires a high-load operation to control a cooling device.

### DETAILED DESCRIPTION

The following disclosure provides many different embodiments, or examples, for implementing different features of the provided subject matter. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. Further, when a first element is described as being “connected” or “coupled” to a second element, such description includes embodiments in which the first and second elements are directly connected or coupled to each other, and also includes embodiments in which the first and second elements are indirectly connected or coupled to each other with one or more other intervening elements in between.

An aspect of the disclosure has been accomplished in view of the above circumstances, and an object of the disclosure is to provide a mud material containing a phenol resin, the mud material having sufficient resistance to erosion by slag and being capable of further reducing a temporal change in fluidity. It is also an object of the disclosure to provide a mud material capable of preventing a phenomenon, in which the mud material charged in a mud gun is cured and sticks to the inside of the mud gun, without attaching a cooling device or the like to the mud gun.

One aspect of the disclosure relates to a mud material including a refractory raw material, an organic binder, and a curing agent, wherein part or all of the organic binder is a novolac-type phenol resin, part or all of the curing agent is a methylene donor, and the methylene donor is at least one selected from the group consisting of hexamethoxymethylmelamine and hexamethoxymethylolmelamine. Such a mud material can reduce a temporal change in fluidity while having sufficient resistance to erosion by slag.

The mud material according to one aspect of the disclosure preferably further includes a stearic acid salt. In this case, a temporal change in fluidity can be reduced while resistance to erosion by slag is enhanced.

Hereinbelow, a preferred embodiment of the disclosure will be described in detail. It should be noted that the present embodiment described below is not intended to unreasonably limit the contents of the disclosure recited in the claims, and all the configurations described in the embodiment are not necessarily essential to the solution of the disclosure.

A mud material according to the embodiment contains a refractory raw material, an organic binder, and a curing agent, part or all of the organic binder is a novolac-type phenol resin, part or all of the curing agent is a methylene donor, and the methylene donor is at least one selected from the group consisting of hexamethoxymethylmelamine and hexamethoxymethylolmelamine.

Refractory Raw Material

The refractory raw material is not particularly limited as long as it is generally contained in a mud material, and examples thereof include an oxide raw material, a carbonaceous raw material, a silicon carbide raw material, and a silicon nitride raw material. Examples of the oxide raw material include an alumina raw material, an alumina-silica raw material, refractory clay, and a silica raw material . Specific examples of the oxide raw material include sintered alumina, fused alumina, shale, bauxite, a chamotte raw material, mullite, andalusite, pyrophyllite, silica stone, and silica fume. Specific examples of the carbonaceous raw material include graphite, amorphous graphite, coal coke, petroleum coke, powders of these cokes, graphite electrode waste, carbon black, coal pitch, and petroleum pitch. Specific examples of the silicon carbide raw material include one produced by the Acheson process and one produced by reduction and carbonization of silica. Specific examples of the silicon nitride raw material include silicon nitride obtained by reduction and nitridation of silica, silicon nitride produced by directly nitriding metallic silicon, and ferro silicon nitride produced by directly nitriding ferro silicon.

Organic Binder

Part or all of the organic binder is a novolac-type phenol resin. The content of the novolac-type phenol resin is preferably 5 to 30 mass %, and more preferably 10 to 25 mass % in outer percentage with respect to 100 mass % of the refractory raw material. When the content of the novolac-type phenol resin is within the above range, it is possible to enhance the development of adhesive strength and the effect of reducing a temporal change. The mud material according to the embodiment may further contain, as the organic binder, coal tar, a resol-type phenol resin or the like in addition to the novolac-type phenol resin without impairing the effects of the disclosure.

Curing Agent

Part or all of the curing agent is a methylene donor. Examples of the methylene donor include hexa(methoxymethyl)melamine, hexamethoxymethylolmelamine, pentamethoxymethylolmelamine, trimethylolmelamine, tris(methoxymethyl)melamine, hexamethylolmelamine, and hexa(alkoxymethyl)melamine, and the methylene donor is preferably at least one selected from the group consisting of hexa(methoxymethyl)melamine and hexamethoxymethylolmelamine. Particularly, hexa(methoxymethyl)melamine (N,N,N′,N′,N″,N″-hexakis(methoxymethyl)-1,3,5-triazine-2,4,6-triamine) can further enhance the development of slag resistance and the effect of reducing a temporal change. The hexa(methoxymethyl)melamine (HMMM) to be used may be liquid or powdery. The mud material according to the embodiment may further contain a general curing agent for phenol resins without impairing the effects of the disclosure. The content of the curing agent is preferably 0.3 to 5.0 mass %, more preferably 0.5 to 4.0 mass %, and particularly preferably 0.8 to 3.5 mass % in outer percentage with respect to 100 mass % of the refractory raw material. When the content of the curing agent is within the above range, it is possible to enhance slag resistance and the effect of reducing a temporal change.

Stearic Acid Salt

The mud material according to the embodiment may further contain a stearic acid salt. This makes it possible to reduce a temporal change in fluidity while enhancing resistance to erosion by slag. The stearic acid salt is preferably a stearic acid metal salt such as lead stearate, zinc stearate, calcium stearate, or magnesium stearate, and is particularly preferably calcium stearate or magnesium stearate. The stearic acid metal salt has a lubricating property and therefore can also enhance the fluidity of the mud material.

The content of the stearic acid salt is preferably 0.1 mass % or more, more preferably 0.3 mass % or more, more preferably 1.0 mass % or more, and even more preferably 2.5 mass % or more in outer percentage with respect to 100 mass % of the refractory raw material. When the content of the stearic acid salt is within the above range, it is possible to further enhance slag resistance and the effect of reducing a temporal change.

Other Raw Materials

For the purpose of enhancing adhesive strength between a taphole and the mud material, the mud material according to the embodiment may further contain one or more kinds of metallic powders. Examples of the metallic powders include aluminum powder, metallic silicon powder, and aluminum-silicon alloy powder.

Production Method

The mud material can be produced by mixing the above-described refractory raw material by a mixer, adding predetermined amounts of the organic binder and the curing agent, and kneading them. The time of kneading of the refractory raw material and the organic binder is not particularly limited as long as a refractory aggregate and the organic binder can sufficiently be mixed, and may be, for example, 10 to 120 minutes.

Hereinbelow, examples of the disclosure will be described in detail.

Experimental Method

A refractory raw material was mixed in a mixer, predetermined amounts of an organic binder, a curing agent, and a stearic acid salt were added, and a resulting mixture was kneaded to obtain a mud material. The refractory raw material had the following composition: pyrophyllite 5 mass %; alumina raw material 60 mass %; clay 5 mass %; SiC+ferro silicon nitride 19 mass %; carbon raw material 11 mass %. As the organic binder, a novolac-type phenol resin having a weight-average molecular weight of about 1500 was used. As the curing agent, liquid hexamethoxymethylmelamine (HMMM) was used in Examples and hexamethylenetetramine used in related art was used in Comparative Examples. As the stearic acid salt, calcium stearate was used and added in Examples 7 to 10. In Comparative Example 2, neither curing agent nor stearic acid salt was added. The contents (mass %) of components of the mud material are shown in Table 1. It should be noted that the content of the curing agent is represented by outer percentage with respect to 100 mass % of the refractory raw material.

TABLE 1

| | | | | | | | | | | | | Comparative | |
|---|---|---|---|---|---|---|---|---|---|---|---|---|---|
| | | Example | | | | | | | | | | Example | |
| | | 1 | 2 | 3 | 4 | 5 | 6 | 7 | 8 | 9 | 10 | 1 | 2 |
| Refractory raw material | | 100 | 100 | 100 | 100 | 100 | 100 | 100 | 100 | 100 | 100 | 100 | 100 |
| Curing agent | Hexa(methoxymethyl) | 0.3 | 0.5 | 1 | 2 | 3 | 5 | 1 | 1 | 1 | 1 | | |
| | melamine (liquid) | | | | | | | | | | | | |
| | Hexamethylenetetramine | | | | | | | | | | | 0.3 | |

| | | | | |
|---|---|---|---|---|
| Ca stearate | 0.05 | 0.1 | 1 | 5 |

The novolac-type phenol resin as the organic binder was added so that an extrusion resistance value on day 0 described below was the same. Specifically, the day just after kneading the mud material was defined as day 0, and the content of the novolac-type phenol resin was adjusted so that an extrusion resistance value at the moment when the mud material exited from an outlet on day 0 was about 135 and an extrusion resistance value at the time of completion of a set stroke of extrusion was about 220. Comparison of temporal changes after day 0 was made by setting the extrusion resistance values on day 0 to the same.

The kneading was performed using a planetary mixer, and a kneading time was set to 20 minutes. The obtained mud material was evaluated in the following manner.

Temporal Change in Fluidity

A temporal change in the fluidity of the mud material was evaluated by a Marshall test. The mud material was charged into a mold having an inlet diameter of Φ60 mm and an outlet diameter of Φ20 mm, and an extrusion load (kgf) at the time of extrusion at a volume velocity of 2.82 cm³/sec was measured by a Marshall tester and defined as an extrusion resistance value. When the extrusion resistance value is large, it can be judged that the mud material is difficult to be injected due to its hardness and has low fluidity.

The mud material was stored at two different temperatures (40° C. and 60° C.), and the extrusion resistance values were measured on day 0, day 14, day 30, day 62, and day 87 after the start of storage to evaluate a temporal change in fluidity. The average of the extrusion resistance values on day 0 after the start of storage was defined as a and the average of the extrusion resistance values after a lapse of time was defined as b to determine a temporal change index of extrusion resistance value by the following formula.

Temporal change index of extrusion resistance value=(b/a)×100

The fluidity is better when the temporal change is smaller, that is, when the temporal change index of extrusion resistance value is closer to 100. The fluidity was evaluated depending on temperature according to the following criteria. In the case of storage at 40° C., the fluidity was evaluated as A, B, or C when the temporal change index (Marshall index) after a lapse of 30 days was less than 250, 250 or more and less than 300, or 300 or more, respectively. In the case of storage at 60° C., the fluidity was evaluated as A, B, or C when the temporal change index after a lapse of 30 days was less than 1000, 1000 or more and less than 2000, or 2000 or more, respectively.

Slag Resistance (Erosion Resistance)

The slag resistance (erosion resistance) of the mud material was evaluated by a rotary drum erosion test. The mud material was charged into a mold and fired at 800° C. for 3 hours to obtain a specimen. The specimen was set in a rotary drum erosion tester and subjected to erosion by blast furnace slag of CaO/SiO₂=1.2 at a test temperature of 1500 to 1600° C. for 2 hours. The size of the specimen was measured before and after the erosion test, and an erosion depth was determined by the following formula.

Erosion depth=size before erosion test−size after erosion test

The erosion depth of Comparative Example 2 was defined as d to determine a slag resistance index by the following formula.

Slag resistance index=(erosion depth/d)×100

The erosion resistance is better when the slag resistance index is smaller, that is, when the slag resistance index is closer to 0. The erosion resistance was evaluated according to the following criteria. The erosion resistance was evaluated as A, B, or C when the slag resistance index was less than 65, 65 or more and less than 80, or 80 or more and less than 100, respectively.

Sticking-Preventing Performance in Mud Gun

The sticking-preventing performance in mud gun was evaluated by a Marshall test. The mud material at ordinary temperature was charged into a mold having an inlet diameter of Φ60 mm and an outlet diameter of Φ20 mm, and a Marshall value (a) just after charging and a Marshall value (b) after maintaining at a predetermined temperature for 9 hours after charging were measured to determine a sticking index by the following formula.

Sticking index=b/a

The sticking-preventing performance in mud gun is better when the sticking index is smaller. The sticking-preventing performance was evaluated according to the following criteria. The sticking-preventing performance in mud gun was evaluated as A, B, or C when the sticking index was less than 4, 4 or more and less than 5, or 5 or more, respectively.

Evaluation Results

The evaluation results are shown in Table 2.

TABLE 2

| | | | | | | | | | | | | | Comparative | |
|---|---|---|---|---|---|---|---|---|---|---|---|---|---|---|
| | | | Example | | | | | | | | | | Example | |
| | | | 1 | 2 | 3 | 4 | 5 | 6 | 7 | 8 | 9 | 10 | 1 | 2 |
| Temporal | Storage | Index | 220 | 225 | 246 | 262 | 283 | 295 | 240 | 230 | 223 | 192 | 343 | — |
| change in | at 40° C. | Evaluation | A | A | A | B | B | B | A | A | A | A | C | — |
| fluidity | After | | | | | | | | | | | | | |
| | lapse of | | | | | | | | | | | | | |
| | 30 days | | | | | | | | | | | | | |
| | Storage | Index | 923 | 997 | 1352 | 1564 | 1697 | 1985 | 1122 | 905 | 515 | 482 | 2512 | — |
| | at 60° C. | Evaluation | A | A | B | B | B | B | B | A | A | A | C | — |
| | After | | | | | | | | | | | | | |
| | lapse of | | | | | | | | | | | | | |
| | 30 days | | | | | | | | | | | | | |

| | | | | | | | | | | | | | |
|---|---|---|---|---|---|---|---|---|---|---|---|---|---|
| Slag resistance | Index | 99 | 98 | 69 | 71 | 70 | 69 | 68 | 64 | 59 | 55 | 81 | 100 |
| Erosion resistance | Evaluation | C | C | B | B | B | B | B | A | A | A | C | Standard |

| | | | | | | | | | | | | | Comparative | |
|---|---|---|---|---|---|---|---|---|---|---|---|---|---|---|
| | | | Example | | | | | | | | | | Example | |
| | | | 1 | 2 | 3 | 4 | 5 | 6 | 7 | 8 | 9 | 10 | 1 | 2 |
| Sticking- | 40° C. | Evaluation | A | A | A | A | A | A | A | A | A | A | C | A |
| preventing | 60° C. | Evaluation | A | A | A | A | A | A | A | A | A | A | C | A |
| performance | 80° C. | Evaluation | A | A | A | A | A | B | A | A | A | A | C | A |
| | 100° C. | Evaluation | A | A | B | B | B | B | B | B | A | A | C | A |

Comparative Example 2 containing neither curing agent nor calcium stearate is a standard for evaluation of slag resistance. Comparative Example 1 using, as a curing agent, hexamethylenetetramine used in related art was evaluated as C in terms of both of the temporal change in fluidity and the erosion resistance. On the other hand, Examples 1 to 10 using hexamethoxymethylmelamine as a curing agent were all evaluated as A or B in terms of the temporal change in fluidity and evaluated as A to C in terms of the erosion resistance, that is, the temporal change in fluidity could be reduced and the erosion resistance could be enhanced. Further, Examples 7 to 10 containing calcium stearate had excellent slag resistance and also could reduce the temporal change in fluidity during storage at high temperature. Such an effect was particularly remarkable in Examples 8 to 10 in which the content of calcium stearate was 0.1 mass % or more with respect to 100 mass % of the refractory raw material. It is considered that in a case where calcium stearate was added, friction during injection was reduced, and therefore the extrusion resistance value was reduced even when the mud material was slightly cured due to high storage temperature. From this, it is understood that the mud material according to the embodiment is very good in durability against transport and storage.

As for the sticking-preventing performance, Comparative Example 1 using, as a curing agent, hexamethylenetetramine used in the related art was evaluated as C at any tested temperature. On the other hand, Examples 1 to 10 using hexamethoxymethylmelamine as a curing agent were all evaluated as A or B. From this, it is understood that when the mud material according to the embodiment is used, a phenomenon, in which the mud material charged in a mud gun is cured and sticks to the inside of the mud gun, can be prevented without attaching a cooling device or the like to the mud gun.

Although the embodiment has been described above in detail, those skilled in the art may easily understand that many modifications may be made without substantially departing from new mater and effects of the disclosure. Therefore, such modifications are all within the scope of the disclosure. For example, in the specification, terms described with terms in broader senses or synonyms at least once may be replaced with such different terms in any part of the specification. Further, the configurations of the embodiment are not limited to those described with reference to the embodiment and various modifications may be made.

1. A mud material comprising a refractory raw material, an organic binder, and a curing agent, wherein
part or all of the organic binder is a novolac-type phenol resin,
part or all of the curing agent is a methylene donor, and wherein
the methylene donor is at least one selected from the group consisting of hexa(methoxymethyl)melamine and hexamethoxymethylolmelamine.

2. The mud material according to claim 1, further comprising a stearic acid salt.
